(19) United States
(12) Patent Application Publication
(10) Pub. No.: US 2006/0161422 A1
(43) Pub. Date: Jul. 20, 2006

(54) Virtual emulation modules, virtual development systems and methods for system-on-chip development

(75) Inventors: Dong-Won Lee, Suwon-si (KR); Yang-Soo Park, Yongin-si (KR); Dong-Sik Cho, Hwaseong-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/316,369

(22) Filed: Dec. 22, 2005

(30) Foreign Application Priority Data
Dec. 22, 2004 (KR) 2004-0110015

(51) Int. Cl. G06F 9/455

(52) U.S. Cl. 703/26

(57) ABSTRACT

A virtual emulation module of a subsystem based on a virtual platform includes a virtual core and a virtual program code including a set of functions. The virtual core is realized using a high-level language and corresponds to a core of the subsystem to be realized onto a system-on-chip (SOC). The set of functions of the virtual core are realized using the high-level language independent of the core of the subsystem. The subsystem to be realized onto the SOC may correspond to a microcontroller unit (MCU) subsystem or to a digital signal processor (DSP) subsystem. The high-level language realizing the virtual core and the functions of the virtual program code may be C-language.

### CROSS-REFERENCE TO RELATED APPLICATIONS

This application claims priority to Korean Patent Application No. 2004-0110015, filed on Dec. 22, 2004, the contents of which are herein incorporated by reference in its entirety.

### BACKGROUND OF THE INVENTION

1. Field of the Invention

The present invention generally relates to development systems and methods for system-on-chip development and, more particularly, to virtual emulation modules, virtual development systems and methods for system-on-chip development.

2. Description of the Related Art

System-on-chip (SOC) enables the integration of subsystems, such as a microcontroller unit (MCU) and a digital signal processor (DSP) subsystem, on a single chip to reduce system size and decrease development cost and time. Designing such a chip requires the iterative development of algorithms and architectures that determine the cost and performance of the end device.

To facilitate faster SOC development cycles, the components used in the subsystems may be proven cores. Reusability of the proven cores can result in decreased development time and cost. SOCs are widely used in communication applications, such as mobile phones and other wireless devices, digital televisions, digital cameras, etc. For example, a digital baseband (DBB) modem chip in a mobile communication terminal can be developed as an SOC.

The use of a field programmable gate array (FPGA) board in the development of SOC systems is known. FPGA boards generally include FPGA chips with hundreds of thousands to millions of gates, analog-to-digital converters, and digital-to-analog converters in a single board. FPGA boards can be used in the design, verification and simulation of an SOC.

Conventional approaches to reduce development time of SOC systems include in-circuit and on-chip emulation, FPGA prototypes and OS emulators. Virtual prototyping offers a way to deliver a software model of hardware before the hardware is available and enables integration of hardware and software during the complete development cycle, which may reduce development cost and schedule.

FIG. 1 is a flow chart illustrating a conventional method of developing an SOC based on a virtual platform. Referring to FIG. 1, the development of first and second subsystems is advanced in parallel, as shown in steps S11 and S12.

The first subsystem includes a core of the first subsystem, a memory device, an interrupt controller, a direct memory access controller (DMAC), a bus and peripheral devices. The developer advances the generation of an emulation module of the first subsystem, porting of software and, in step S13, performs a verification of the components that do not interact with the second subsystem.

The second subsystem includes a core of the second subsystem, a memory device, an interrupt controller, a DMAC, a bus and several peripheral devices. The developer advances the generation of an emulation module of the second subsystems, porting of software and verification in step S14.

After the respective verifications in steps S13 and S14, the emulation modules of the subsystems are integrated in step S15. Finally, interaction between the first and second subsystem emulation modules is verified in step S16.

In general, there exists substantial necessity to exchange signals between the emulation modules of the subsystems even during the verifications steps 13 and 14, which are executed to verify respective modules independently before the integration. This necessity for exchanging signals tends to be a source of delay in the development process.

For example, the cores of the first and second subsystems may be a MCU core or a DSP core. In the case that the first subsystem is a MCU subsystem, the core of the MCU subsystem is typically an ARM core (ARM offers a wide range of processor cores). The second subsystem may be a DSP subsystem that is selected among cores that are available from various manufacturers. Tools such as a debugging tools which are essential to the SOC development based on a virtual platform, may differ according to the kinds of cores. As a result of the diversity of the cores, there may be delays due to, for example, obtaining development tools and acquiring knowledge of assembly codes corresponding to the chosen DSP core.

As described above, delay in development of one subsystem may cause delay in the verification process of other subsystems and may hinder development of an entire system.

### SUMMARY OF THE INVENTION

Exemplary embodiments of the present invention provide a virtual emulation module of a subsystem, a virtual development system, and a virtual development method, based on a virtual platform.

In an exemplary embodiment of the present invention, a virtual emulation module of a subsystem based on a virtual platform includes a virtual core of the subsystem and a virtual program code of the subsystem, the virtual program code includes a set of functions. The virtual core is realized using a high-level language and corresponds to a core of the subsystem to be realized onto a system-on-chip (SOC). The set of functions of the virtual program code are realized using the high-level language independent of the core of the subsystem.

The subsystem to be realized onto the SOC may correspond to a microcontroller unit (MCU) subsystem. In an exemplary embodiment of the present invention, the MCU subsystem includes a bus, a MCU core coupled to the bus and configured to execute the program code of the MCU subsystem, at least one interrupt controller coupled to the bus, at least one bus controller coupled to the bus, and a memory device for storing the program code, the program code to be executed by the MCU core.

The subsystem to be realized onto the SOC may correspond to a digital signal processor (DSP) subsystem. In an exemplary embodiment of the present invention, the DSP subsystem includes a bus, a DSP core coupled to the bus and configured to execute the program code of the DSP subsystem, at least one interrupt controller coupled to the bus, at least one bus controller corresponding to the bus, and the memory device for storing the program code, the program code to be executed by the DSP core. In an exemplary embodiment of the present invention, the high-level language realizing the virtual core and the set of functions of the virtual program code is C-language.

In an exemplary embodiment of the present invention a virtual development system based on a virtual platform includes a first emulation module of a first subsystem and a second emulation module of a second subsystem operating interactively with the first subsystem. The first and second emulation modules are executed interactively with each other in a virtual environment, and the second emulation module of the second subsystem corresponds to a virtual emulation module. The virtual emulation module includes a virtual core that is realized using a high-level language and corresponds to a core of the second subsystem to be realized onto an SOC. The virtual emulation module further includes a virtual program code including a set of functions, the set of functions are realized using the high-level language independent of the core of the second subsystem.

The second subsystem to be realized onto the SOC may correspond to a MCU subsystem or a DSP subsystem.

In an exemplary embodiment of the present invention, a virtual development method based on a virtual platform comprises verifying a first emulation module of a first subsystem to be realized onto a system-on-chip (SOC); verifying a virtual emulation module of a second subsystem, the virtual emulation module corresponding to a second emulation module of the second subsystem to be realized onto the SOC. The virtual development method further comprises integrating the first emulation module of the first subsystem and the virtual emulation module of the second subsystem, and verifying the first emulation module of the first subsystem and the virtual emulation module of the second subsystem, executing the first emulation module and the virtual emulation module interactively with each other in a virtual environment.

### BRIEF DESCRIPTION OF THE DRAWINGS

The present invention will become more apparent to those of ordinary skill in the art when descriptions of exemplary embodiments thereof are read with reference to the accompanying drawings, of which:

FIG. 1 is a flow chart illustrating a conventional method of developing a system-on-chip (SOC) based on a virtual platform.

FIG. 2 is a block diagram illustrating a configuration of subsystems in an SOC according to an exemplary embodiment of the present invention.

FIG. 3 is a block diagram illustrating a virtual development system based on a virtual platform by using a virtual emulation module of a subsystem according to an exemplary embodiment of the present invention.

FIG. 4 is a flow chart illustrating a virtual development method based on a virtual platform by using a virtual emulation module of a subsystem according to an exemplary embodiment of the present invention.

### DETAILED DESCRIPTION OF THE EXEMPLARY EMBODIMENTS

Hereinafter, the exemplary embodiments of the present invention will be described with reference to the accompanying drawings. Like reference numerals refer to similar or identical elements throughout the description of the figures. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

It will be understood that although the terms first and second are used herein to describe various elements, these elements should not be limited by these terms. These terms are only used to distinguish one element from another element. Thus, a first item could be termed a second item, and similarly, a second item may be termed a first item without departing from the teachings of the present invention. As used herein, the term “and/or” includes any and all combinations of one or more of the associated listed items. The symbol “/” may also be used as a shorthand notation for “and/or”.

It should also be noted that in some alternative implementations, the functions/actions noted in the blocks may occur out of the order presented in the flowcharts. For example, two blocks shown in succession may be executed substantially concurrently or the blocks may sometimes be executed in the reverse order, depending upon the functionality/actions involved.

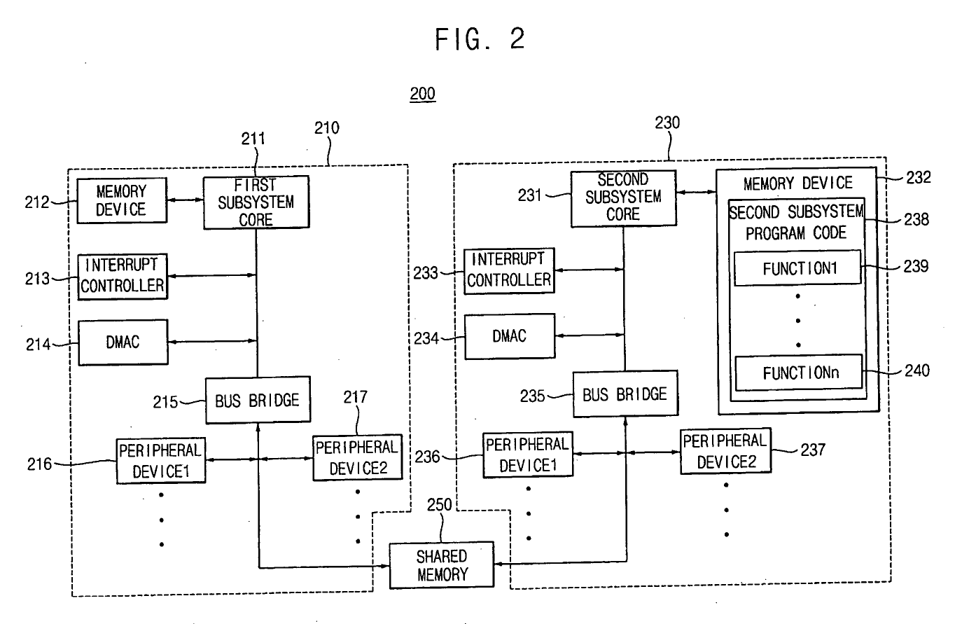

FIG. 2 is a block diagram illustrating a configuration of subsystems in an SOC according to an exemplary embodiment of the present invention. Referring to FIG. 2, an SOC 200 includes a first subsystem 210, a second subsystem 230, and a shared memory 250 which is shared between the subsystems 210 and 230.

The first subsystem 210 includes a first subsystem core 211, a memory device 212 and an interrupt controller 213. In addition, the first subsystem 210 may further include a direct memory access controller (DMAC) 214, a bus controller (for example, a bus bridge) 215 and other peripheral devices 216 and 217. In the memory device 212 of the first subsystem 210, a program code (not shown) of the first subsystem 210, which is executed by the core 211, is loaded.

The second subsystem 230 includes a second subsystem core 231, a memory device 232 and an interrupt controller 233. In addition, the second subsystem 230 may further include a DMAC 234, a bus controller (for example a bus bridge) 235 and peripheral devices 236 and 237. A program code 238 of the second subsystem 230, which is executed by the second subsystem core 231, is loaded in the memory device 232 of the second subsystem 230.

The first subsystem 210 may be a microcontroller unit (MCU) subsystem. The first subsystem core 211 may be a MCU core, for example, an ARM CPU core. The second subsystem 230 may be a digital signal processor (DSP) subsystem or another MCU subsystem. In an exemplary embodiment of the present invention, when the second subsystem 230 is the DSP subsystem, the second subsystem core 231 is a DSP core. When the second subsystem 230 is the DSP subsystem, the program code 238 of the second subsystem 230, which is loaded in the memory device 232 of the second subsystem 230, may include the functions 239 and 240 which are executed by the second subsystem core 231.

The functions 239 and 240 may be realized differently, according to a particular functional purpose of the SOC 200 including the first subsystem 210 and second subsystem 230. For example, in the case of a modem chip in a mobile communication terminal, the functions 239 and 240 may be any functions that are necessary to operate the modem chip.

For example, interactions between the first subsystem 210 and the second subsystem 230 may be achieved as described below.

First, a task and data which are required to be processed in the second subsystem 230 are loaded in the shared memory 250 by the first subsystem. A request for the task is conducted by an interrupt signal from the first subsystem 210 to the second subsystem 230.

In response to the interrupt signal from the first subsystem 210, an interrupt handler is executed in the second subsystem 230. The interrupt handler is included in the virtual program code 238 of the second subsystem 230, which is loaded in the memory device 232. An interrupt service routine (ISR) is executed according to the interrupt handler.

Upon the ISR of the second subsystem 230, the kind of task requested from the first subsystem 210 is determined, and the data to be processed is retrieved by an access to the shared memory 250. From among the set of functions included in the virtual program code 238 of the second subsystem 230, which is loaded in the memory device 232, the function requested by the first subsystem 210 is executed. Results of the execution are written in the shared memory 250.

The first subsystem 210 confirms whether the second subsystem 230 has finished the requested task, by polling a specific region of the shared memory 250. Recognizing completion of the task, the first subsystem 210 fetches the results of the execution from the shared memory 250.

It will be understood that the above method of interfacing through an interaction between the first subsystem 210 and the second subsystem 230 describes one embodiment of the present invention, and that any method of interfacing the first subsystem 210 and the second subsystem 230 should be suitable for implementing the present invention.

The first subsystem 210 corresponds to a first subsystem emulation module in the development environment based on the virtual platform. The second subsystem 230 exists as a second subsystem emulation module in the development environment based on the virtual platform.

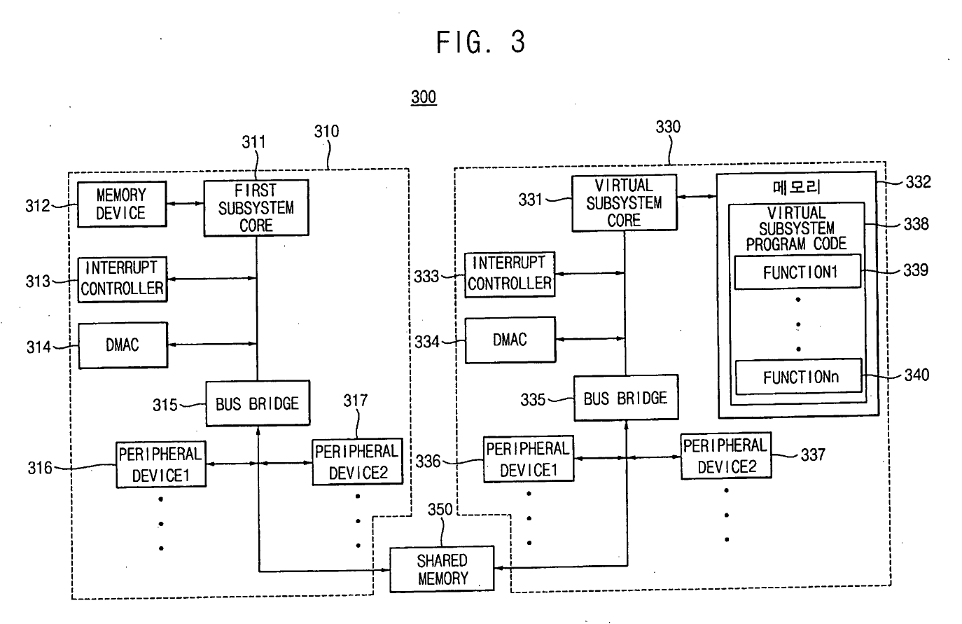

FIG. 3 is a block diagram illustrating a virtual development system based on a virtual platform by using a virtual emulation module of a subsystem according to an exemplary embodiment of the present invention. Referring to FIG. 3, it will be readily understood that the SOC subsystems of FIG. 2 may exist as corresponding emulation modules in the virtual development system based on the virtual platform.

A first subsystem emulation module 310 of FIG. 3 corresponds to the first subsystem 210 illustrated in FIG. 2. The components of the first subsystem 210 of FIG. 2 include a first subsystem core 211, a memory device 212 and an interrupt controller 213, a direct memory access controller (DMAC) 214, a bus controller (for example, a bus bridge) 215 and peripheral devices 216 and 217, which are realized onto an SOC. Those components 211 to 217, respectively, correspond to components 311 to 317, respectively, of the first subsystem emulation module 310.

In the second subsystem emulation module 330 of FIG. 3, a virtual subsystem core 331 replaces the second subsystem core 231 of FIG. 2. In addition, a virtual program code 338 of FIG. 3 replaces the program code 238 of the second subsystem 230 of FIG. 2. The functions 339 and 340 of the virtual program code 338, which correspond one-to-one to the functions 239 and 240 of FIG. 2, may be realized using a high-level language. The components 333 to 337, respectively, of the second subsystem emulation module 330 correspond to the interrupt controller 233, the DMAC 234, the bus bridge 235 and other peripheral devices 236 and 237 of FIG. 2.

The core of the virtual subsystem core 331 may be realized using a high-level language. The input of an interrupt signal, input of a clock and interface connected to the bus of the subsystem, which are required in a system based on a virtual platform, are provided. The above configuration of the virtual subsystem core 331 may be changed, for example, according to the environment based on the virtual platform or according to an intended real subsystem core.

As the above description, the functions 239 and 240 loaded in the memory device 232 may be substituted by the functions 339 and 340, which are realized using the high-level language. An assembly language dependent on a core of a real subsystem is excluded, and only the high-level language executing functions regardless of the core is used in realizing the functions 339 and 340.

For example, when the second subsystem 230 is a digital signal processor (DSP) subsystem, the functions related to digital signal processing can be included in the program code 238 which is loaded in the memory device 232 to be executed by the second subsystem core 231. As described above, when the intended SOC is a modem chip of a mobile communication terminal, the set of functions required for operating the modem chip may be included in the second subsystem program code.

The high-level language may be C-language, which is commonly used in commercially available environments based on a virtual platform (for example, MAXSIM, available from AXSYS). It will be understood that any suitable language can be used to implement the present invention.

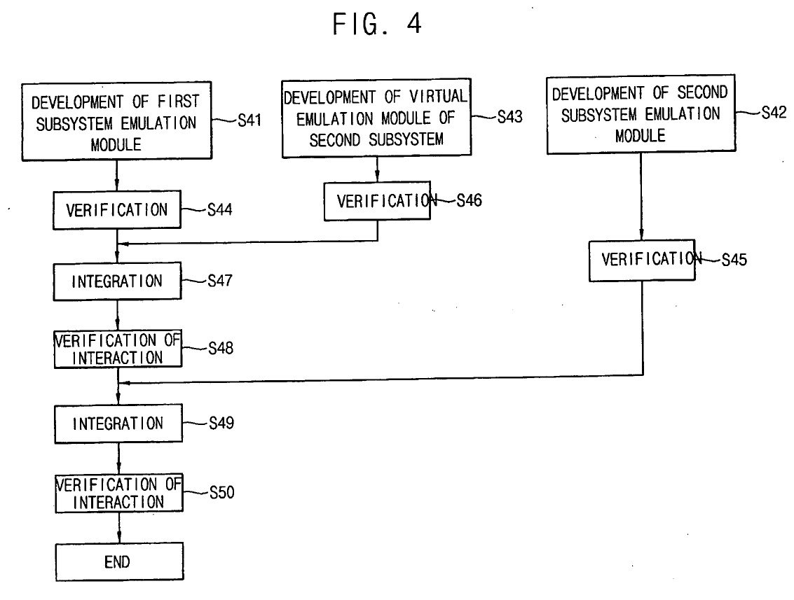

FIG. 4 is a flow chart illustrating a virtual development method based on a virtual platform by using a virtual emulation module of a subsystem according to an exemplary embodiment of the present invention.

Referring to FIG. 4, a first subsystem emulation module and a second subsystem emulation module are developed in parallel, as shown in steps S41 and S42. With the development of the second subsystem emulation module, a virtual emulation module of the second subsystem is developed from the beginning, as shown in step S43. The virtual emulation module of the second subsystem is composed of a virtual core 331, and a virtual program code 338 including the functions 339 and 340, as shown in FIG. 3. The functions 339 and 340 of the virtual program code are realized using a high-level language.

As shown in FIG. 2, the first subsystem includes a first subsystem core, a memory device and an interrupt controller, a direct memory access controller (DMAC), a bus and peripheral devices. In step S44, the developer advances development of an emulation module of the first subsystem, porting of software and verification in the development system based on the virtual platform.

The second subsystem includes a second subsystem core, a memory device, an interrupt controller, a DMAC, a bus and peripheral devices. In step S45, the developer advances development of an emulation module of the second subsystem, porting of software and verification in the development system of the virtual platform.

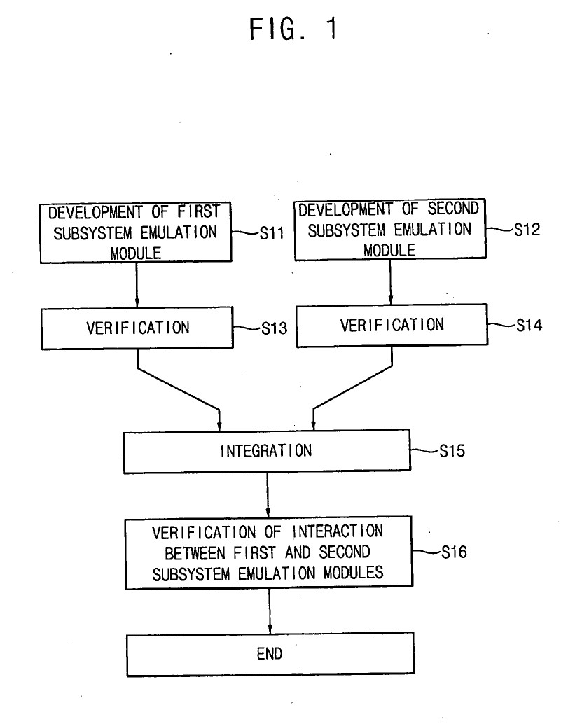

Unlike the conventional method of developing an SOC illustrated in FIG. 1, in a process of developing an SOC according to an exemplary embodiment of the present invention, a verification of the virtual emulation module of the second subsystem (in step S46) precedes a verification of the second subsystem emulation module (in step S45). The advance verification of the virtual emulation module includes verifications of the virtual core 331 and the virtual program code 338. The virtual core 331 and the virtual program code 338 included in the virtual emulation module of the second subsystem 330 are realized using the high-level language. After verifying the emulation module of the first subsystem and the virtual emulation module of the second subsystem, both the modules are integrated, in step S47, and verified, in step S48. The operations of the emulation module of the first subsystem are verified even in a stage where the development of the emulation module of the second subsystem is not finished.

After the emulation module of the second subsystem is verified in step S45, it is integrated with the emulation module of the first subsystem in step S49. A verification of interaction between the emulation modules of the first and second subsystems is conducted in step S50.

According to the exemplary embodiments of the present invention as described above, it is possible to verify the interaction between the subsystems without delay. The advance verification may be conducted by developing the virtual emulation module of the subsystem including the virtual core and the virtual program code realized using a high-level language. As a result of the advance verification, delay in a verification of one subsystem due to a development of another subsystem may be prevented.

Although the exemplary embodiments of the present invention have been described in detail with reference to the accompanying drawings for the purpose of illustration, it is to be understood that the inventive processes and apparatus are not to be construed as limited thereby. It will be readily apparent to those of reasonable skill in the art that various modifications to the foregoing exemplary embodiments may be made without departing from the scope of invention as defined by the appended claims, with equivalents of the claims to be included therein.

What is claimed is:

1. A virtual emulation module of a subsystem, the virtual emulation module based on a virtual platform, the virtual emulation module comprising:
a virtual core of the subsystem that corresponds to a core of the subsystem to be realized onto a system-on-chip (SOC), wherein the virtual core of the subsystem is realized using a high-level language; and
a virtual program code of the subsystem that corresponds to a program code of the subsystem, wherein the virtual program code comprises a set of functions, the set of functions of the virtual program code are realized using the high-level language independent of the core of the subsystem.

2. The virtual emulation module of claim 1, wherein the subsystem to be realized onto the SOC corresponds to a microcontroller unit (MCU) subsystem.

3. The virtual emulation module of claim 2, wherein the MCU subsystem comprises:
a bus;
a MCU core coupled to the bus and configured to execute the program code of the MCU subsystem;
at least one interrupt controller coupled to the bus;
at least one bus controller coupled to the bus; and
a memory device for storing the program code, the program code to be executed by the MCU core.

4. The virtual emulation module of claim 1, wherein the subsystem to be realized onto the SOC corresponds to a digital signal processor (DSP) subsystem.

5. The virtual emulation module of claim 4, wherein the DSP subsystem comprises:
a bus;
a DSP core coupled to the bus and configured to execute the program code of the DSP subsystem;
at least one interrupt controller coupled to the bus;
at least one bus controller coupled to the bus; and
a memory device for storing the program code, the program code to be executed by the DSP core.

6. The virtual emulation module of claim 1, wherein the high-level language is C-language.

7. A virtual development system based on a virtual platform, comprising:
a first emulation module of a first subsystem; and
a second emulation module of a second subsystem operating interactively with the first subsystem,
wherein the first and second emulation modules are executed interactively with each other in a virtual environment, and
wherein the second emulation module of the second subsystem corresponds to a virtual emulation module comprising:
a virtual core of the second subsystem that corresponds to a core of the second subsystem to be realized onto a system-on-chip (SOC), the virtual core of the second subsystem is realized using a high-level language; and
a virtual program code of the second subsystem that corresponds to a program code of the second subsystem comprising a set of functions, the set of functions of the virtual program code are realized using the high-level language independent of the core of the second subsystem.

8. The virtual development system of claim 7, wherein the second subsystem to be realized onto the SOC corresponds to a microcontroller unit (MCU) subsystem.

9. The virtual development system of claim 8, wherein the MCU subsystem comprises:
a bus;
a MCU core coupled to the bus and configured to execute the program code of the MCU subsystem;
at least one interrupt controller coupled to the bus;
at least one bus controller coupled to the bus; and
a memory device for storing the program code, the program code to be executed by the MCU core.

10. The virtual development system of claim 7, wherein the second subsystem to be realized onto the SOC corresponds to a digital signal processor (DSP) subsystem.

11. The virtual development system of claim 10, wherein the DSP subsystem comprises:
a bus;
a DSP core coupled to the bus and configured to execute the program code of the DSP subsystem;
at least one interrupt controller coupled to the bus;
at least one bus controller coupled to the bus; and
a memory device for storing the program code, the program code to be executed by the DSP core.

12. The virtual development system of claim 7, wherein the high-level language realizing the virtual core and the set of functions of the virtual program code is C-language.

13. A virtual development method based on a virtual platform, the method comprising:
verifying a first emulation module of a first subsystem to be realized onto a system-on-chip (SOC);
verifying a virtual emulation module of a second subsystem, the virtual emulation module corresponding to a second emulation module of the second subsystem to be realized onto the SOC, the virtual emulation module being realized using a high-level language;
integrating the first emulation module of the first subsystem and the virtual emulation module of the second subsystem; and
verifying the first emulation module of the first subsystem and the virtual emulation module of the second subsystem, executing the first emulation module and the virtual emulation module interactively with each other in a virtual environment.

14. The virtual development method of claim 13, wherein the virtual emulation module of the second subsystem comprises:
a virtual core of the second subsystem corresponding to a core of the second subsystem to be realized onto a system-on-chip (SOC), the virtual core of the second subsystem being realized using a high-level language; and
a virtual program code of the second subsystem corresponding to a program code of the second subsystem, the virtual program code comprising a set of functions, the set of functions of the virtual program code being realized using the high-level language independent of the core of the second subsystem.

15. The virtual development method of claim 14, wherein verifying the virtual emulation module of the second subsystem comprises integrating the virtual subsystem core and the virtual subsystem program code.

16. The virtual development method of claim 14, wherein the second subsystem to be realized onto the SOC corresponds to a microcontroller unit (MCU) subsystem.

17. The virtual development method of claim 16, wherein the MCU subsystem comprises:
a bus;
a MCU core coupled to the bus and configured to execute the program code of the MCU subsystem;
at least one interrupt controller coupled to the bus;
at least one bus controller coupled to the bus; and
a memory device for storing the program code, the program code being executed by the MCU core.

18. The virtual development method of claim 14, wherein the second subsystem to be realized onto the SOC corresponds to a digital signal processor (DSP) subsystem.

19. The virtual development method of claim 18, wherein the DSP subsystem comprises:
a bus;
a DSP core coupled to the bus and configured to execute the program code of the DSP subsystem;
at least one interrupt controller coupled to the bus;
at least one bus controller coupled to the bus; and
the memory device for storing the program code, the program code being executed by the DSP core.

20. The virtual development method of claim 14, wherein the high-level language realizing the virtual core and the set of functions of the virtual program code is C-language.
